(19) United States
(12) Patent Application Publication
(10) Pub. No.: US 2007/0262984 A1
(43) Pub. Date: Nov. 15, 2007

(54) Automatic Generation of Building Instructions for Building Block Models

(75) Inventor: Martin Pruss, Fredericia (DK)

Correspondence Address: DAY PITNEY LLP, 7 TIMES SQUARE, NEW YORK, NY, 10036-7311, US

(73) Assignee: LEGO A/S, Billund (DK)

(21) Appl. No.: 11/629,732

(22) PCT Filed: Jun. 16, 2005
(86) PCT No.: PCT/DK05/00394

§ 371 Date: Jun. 22, 2007

(30) Foreign Application Priority Data
Jun. 17, 2004 (DK) PA 2004 00942

(51) Int. Cl. G06T 17/00

(52) U.S. Cl. 345/420

(57) ABSTRACT

A computer-implemented method of generating building instructions for a building block model, comprising: retrieving a digital representation of the building block model; wherein said digital representation is indicative of a sequential construction order in which a plurality of virtual building blocks have been positioned in response to user commands during a computer-implemented virtual construction process, said virtual construction process resulting in a virtual building block model; and generating graphical representations of at least a first and a second part-model of respective first and second subsets of said plurality of virtual building blocks; wherein the second subset includes the first subset and a predetermined number of additional virtual building blocks of said plurality of virtual building blocks; and wherein the additional virtual building blocks are subsequent to all virtual building blocks in the first subset with respect to a sequential instruction order derived from the sequential construction order.

The present invention relates to the generation of building instructions for building block models.

There are various known types of modelling concepts of physical construction toy sets. Especially, concepts using modular or semi-modular concepts are very popular as they provide an interesting and challenging play experience. Typically, these concepts provide a set of pre-manufactured elements or building blocks that can be interconnected with each other in some predetermined way according to modules of the pre-manufactured elements. The pre-manufactured elements resemble well-known objects adapted to a specific modelling task. Thus in e.g. building a model of a house the elements may resemble wall bricks, roof tiles, doors, and windows. The object of selecting the elements in this way is that the work involved with the building of a model of a house is reduced significantly compared to a situation where all details of the house are to be defined each time a new model should be made. However, the complete freedom in building a house or another object is traded off for the simplicity of building the model.

For example, the toy construction sets available under the name LEGO comprise a plurality of different types of interconnectable building blocks having protrusions and corresponding cavities as connecting elements. The connecting elements are arranged according to regular grid patterns, thereby allowing a wide variety of interconnections between building blocks.

Typically, such toy construction sets comprise a set of building blocks suitable for creating one or more building block models, e.g. an animal, a robot, or another creature, a car, an airplane, a spaceship, a building, or the like. Typically, a construction set further includes printed building instructions or assembly instructions that illustrate how to construct a certain model from the building blocks of the set. Nevertheless, it is an interesting feature of such construction sets that they inspire children to create their own models.

Typically, the building instructions enclosed in a toy construction set comprise a sequence of pictures illustrating step by step how and in which order to add the building blocks to the model. Such building instructions have the advantage that they are easy to follow, even for children without great experience in toy construction sets and/or without reading skills.

However, such building instructions have the disadvantage that they are labour-intensive and expensive to produce. Typically, the model for which building instructions are to be created is broken down into reasonable building steps and each building step is subsequently drawn in a CAD system and finally printed.

More recently, building instructions have been generated in electronic rather than in printed form. In particular, animated building instructions where the more complicated building steps are animated. The production of such building instructions, however, still involves a design and a drawing/animation of the building steps by skilled designers.

The above production processes have the disadvantage that they require great skill and are labour-intensive. As a consequence, building instructions typically only exist for building block models designed by the manufacturer of the building blocks. In particular, the above prior art methods for generating building instructions are not suitable for children who wish to produce building instructions for their own models, which would allow them to share their models with their friends.

The design of effective, easy-to-understand step-by-step building instructions has also been the subject of some research. The Internet publication “Designing Effective Step-by-Step Assembly Instructions”, by M. Agrawala et al., retrieved from http://graphics.stanford.edu/papers/assembly_instructions/, describes design principles for effective assembly instructions based on cognitive psychology. This article further discloses a computerised system for generating assembly instructions based on information about each of the objects to be assembled, the assembly orientation and the camera viewpoint for the graphical rendering, grouping information, information about fasteners, the significance of the parts, symmetries, and about constraints on the order of assembly. Based on this input, the system calculates a sequence of assembly steps based on an extensive search algorithm taking the given constraints into consideration.

It is a problem of the above prior art system that it is computationally expensive and requires complicated input data, thus requiring a high degree of abstract thinking from the user.

Hence, in particular, none of the above prior art methods for generating building instructions are suitable for children who wish to produce building instructions for their own models, which would allow them to share their models with their friends and further improve the play experience.

The above and other problems are solved by a computer-implemented method of generating building instructions for a building block model, the model including a plurality of building blocks; the method comprising

a) retrieving a digital representation of the building block model; wherein said digital representation is indicative of a sequential construction order in which a plurality of virtual building blocks have been positioned in response to user commands during a computer-implemented virtual construction process, said virtual construction process resulting in a virtual building block model; and

b) generating graphical representations of at least a first and a second part-model of respective first and second subsets of said plurality of virtual building blocks; wherein the second subset includes the first subset and a predetermined number of additional virtual building blocks of said plurality of virtual building blocks; and wherein the additional virtual building blocks are subsequent to all virtual building blocks in the first subset with respect to a sequential instruction order derived from the sequential construction order.

Consequently, it has been realised that a user who builds a virtual version of the model for which building instructions are to be generated employs a natural sequence of assembly steps. Hence, by recording and storing the order of assembly steps employed by the user, the order of steps can be used in the generation of building instructions. It has turned out that the building instructions generated by this computationally simple method are easy to understand by other users, in particular children.

Furthermore, as the only input to the building instruction is the digital representation of the virtual model and the information about the sequence of virtual construction steps recorded during the virtual model generation, the building instructions are easy for a user to generate without requiring the user to posses design skills or abstract knowledge about geometry, constraints, etc.

The positioning of virtual building blocks may include a selection of a desired orientation of the building block, e.g. with respect to a reference coordinate system. Consequently, in some embodiments, positioning of a virtual building block includes positioning and selecting an orientation of the virtual building block with respect to a 3-dimensional coordinate system.

In a preferred embodiment, the digital representation comprises a sequence of data records, each representing one of the plurality of building blocks; and said sequence represents the sequential construction order in which the virtual building blocks where positioned during the model generation. Consequently, as the data records for the individual building blocks are stored in the same order as they are added to or repositioned within the model, the information about the sequential order is automatically included in the digital representation without the need for additional data items, thereby providing a particularly compact representation. Furthermore, when generating the graphical representation of the part-models, no search through the data records is required in order to identify the next building block(s) to be added in the subsequent step.

In an alternative embodiment, the digital representation comprises a plurality of data records, each representing one of the plurality of building blocks; and wherein each data record includes a data item indicative of a position of the corresponding virtual building block in said sequential order in which the virtual building blocks where positioned during the model generation. Hence, as the position of each building block in the sequential ordering is explicitly stored, the method does not impose any ordering constraints on the format of the digital representation. It is understood that the ordering information may be included in the digital representation in a variety of ways, e.g. by assigning a sequence number to each building block, by storing the data records as a linked list, where each data record includes a pointer to the next building block in the sequence, or the like.

In one embodiment, the sequential instruction order is identical to the recorded sequential construction order, thereby avoiding any need for re-sorting the stored data records. In another preferred embodiment, the method further comprises modifying the sequential construction order according to a predetermined sorting criterion to obtain the sequential instruction order, thereby providing a mechanism for taking limitations of a physical construction process into account which are not implemented in the virtual construction process. In some embodiments, the modification of the sequential order is performed before storing the digital representation, resulting in a digital representation of the model that includes information about the construction sequence and about any modifications of the sequential order. For example, the building block data records may be stored in the modified sequential order. Alternatively, the digital representation is stored in the recorded construction order, and any modifications are performed as part of the generation of the graphical representations.

In particular it has turned out that particularly easy-to-follow user instructions are obtained when the digital representation includes respective position coordinates of each of the virtual building blocks with respect to a predetermined coordinate system, and when said sorting criterion includes said position coordinates along at least one predetermined direction, preferably a direction projecting out from a base plate onto which the building block model is constructed.

In another preferred embodiment, the method further comprises generating the digital representation of the building block model by means of a computer-implemented construction environment for interactively constructing a virtual building block model, wherein the generating includes:
positioning a plurality of virtual building blocks in respective positions relative to another, resulting in a virtual building block model, wherein the virtual building blocks are positioned in a sequential construction order in response to user commands;
storing the digital representation of said virtual building block model including information about said sequential construction order.

Preferably, the computer-implemented construction environment for interactively constructing a virtual building block model comprises a computer program that, when executed on a computer, provides a graphical user interface allowing a user to manipulate virtual building block models, including operations like selecting building blocks, adding building blocks to the model, deleting building blocks from the model, changing the orientation of a building block, changing properties of a building block, e.g. color, type, size, and/or the like, viewing a model, saving a digital representation of a model, loading a digital representation of a previously saved model, etc.

Preferably, the virtual building blocks are virtual counterparts of corresponding physical building blocks, i.e. have corresponding relative size, shape, color, etc.

In a further preferred embodiment, the computer-implemented construction environment is configured to enforce a predetermined set of restrictions imposed on the relative positions of building blocks with respect to each other. Preferably, the restrictions correspond to the corresponding restrictions applicable to the corresponding physical building blocks, thereby ensuring that a virtual building block model actually can be constructed from the corresponding physical building blocks as well. Hence, it is an advantage, that the method ensures that the generated building instructions actually are realisable, i.e. lead to a desired result.

One example of such restrictions is collision detection between a newly placed building block and previously placed building block. Furthermore, in many toy construction sets the building blocks are interconnectable with each other, i.e. they comprise connection elements that are adapted to engage with connection elements of other such building blocks. Such connection elements impose further restrictions on possible placements of building blocks, as a connection is only possible between compatible connection elements, e.g. protrusions that fit into corresponding cavities, when placed in a correct position relative to each other. Consequently, in a preferred embodiment, the computer-implemented construction environment is configured to retrieve connectivity information of the corresponding connection elements of the virtual building blocks indicative of whether the connection elements of two building blocks positioned in a predetermined proximity from each other provide a connection between the two building blocks.

Preferably, each graphical representation includes a graphical rendering of a partial building block model, i.e. a building block model comprising the building blocks of a part-sequence of the sequential ordering. In further preferred embodiment, each of the first and second subsets constitutes an uninterrupted part-sequence of virtual building blocks from the stored sequential order, thereby providing easy-to-follow building instructions where each graphical representation corresponds to a step in the building process where a predetermined number of building blocks are added to the model. A user can easily determine which building blocks are to be added in each step and how they are to be added by comparing two consecutive graphical representations.

When the method further comprises providing a user interface for viewing the graphical representations, wherein the user interface preferably facilitates a user-controlled manipulation of the generated graphical representations, the digital representation of the building block model may be conveniently viewed on a computer. In particular, since the digital representation of the model includes all the information required for the generation of the building instructions, building instructions may conveniently be communicated from one computer to another, e.g. stored on a storage medium, sent via a communications network, e.g. as an e-mail attachment, uploaded on a web server, or the like. A recipient of the digital representation may thus view the graphical representation and manipulate it, e.g. change a viewing angle, zoom, change viewing options, and/or the like. Consequently, users may easily communicate their building instructions to friends. It is a further advantage that the digital representation does not need to include a graphical rendering of each step of the instructions, thereby keeping the file size of the digital representation small. Furthermore, since the digital representation preferably comprises all relevant model information, the recipient of a model may even modify the model before generating the building instructions.

Preferably, the user interface provides functionality for viewing selected ones of the generated graphical representations and providing operations like zoom, rotate, etc. Hence, the user can choose and even change a preferred viewpoint when viewing the instructions, thereby avoiding any problems caused by a newly placed building block placed in a position where it is not visible without the need of computationally expensive 3D calculations. More preferably, the user interface provides functionality for viewing a sequence of graphical representations of part-models where each graphical representation is displayed for a predetermined period of time before the next graphical representation is automatically displayed. Hence, the user may view the building instructions as a slide show or animation of the actual building process, thereby further facilitating the understanding of the instructions.

Preferably, the user interface further provides functionality for printing at least one of the graphical representations and/or for storing at least one of the graphical representations in a predetermined file format, thereby allowing the generation of printed and/or electronic building instructions. Examples of suitable file formats include HTML, XML, BMP, TIFF, etc.

In a preferred embodiment, the predetermined number of additional virtual building blocks added in a step of the step-wise instructions is user-selectable, thereby allowing a user to select between very detailed step by step instructions, wherein e.g. each step corresponds to the placement of a single new building block, and very compact instructions where each step corresponds to a larger number of newly placed blocks. It has turned out that for many models easy-to-follow instructions are achieved when the predetermined number is selected between 1 and 6, preferably between 2 and 4. However, other step sizes are possible as well. In some embodiments the number of building blocks added in each step is the same in all steps. In other embodiments, the number of additional blocks added may be different for different steps of the building instructions. For example, the step-size may be controlled by a user for each step, thereby allowing the generation of more fine-grained instructions for more complicated parts of the construction.

When the method further comprises presenting the second graphical representation of the model together with a graphical representation of the additional building blocks which distinguish the second part model from the first part model, a particularly effective building instruction is provided, since the user can immediately see which building blocks are added in each step. Alternatively or additionally, the newly placed building blocks may be highlighted in a different way, e.g. by rendering the newly placed building blocks in the part-model in a different color, semi-transparent, with a bounding box, or the like.

The present invention can be implemented in different ways including the method described above and in the following, a data processing system, and further product means, each yielding one or more of the benefits and advantages described in connection with the first-mentioned method, and each having one or more preferred embodiments corresponding to the preferred embodiments described in connection with the first-mentioned method and disclosed in the dependant claims related thereto.

In particular, the features of the method described above and in the following may be implemented in software and carried out on a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

Accordingly, the invention further relates to a data processing system adapted to perform the method described above and in the following. The invention further relates to a computer program comprising program code means for performing all the steps of the method described above and in the following when said program is run on a computer. The invention further relates to a computer program product comprising program code means for performing the method described above and in the following when said computer program product is run on a computer. The program code means may be stored on a computer readable medium and/or embodied as a propagated data signal.

Preferably, the computer program comprises a first software component for performing steps a) and b) of the first-mentioned method; and a second software component for performing the step of generating the digital representation of the building block model by means of a computer-implemented construction environment for interactively constructing a virtual building block model, thereby providing a separate software component for reading the digital representation of a model and presenting the corresponding building instructions. Consequently, when communicating the building instructions a user may communicate the digital representation together with the second software component, thereby providing a compact, self-contained representation of the building instructions that can be viewed by the recipient without the need for additional software.

The invention will be explained more fully below in connection with a preferred embodiment and with reference to the drawing, in which:

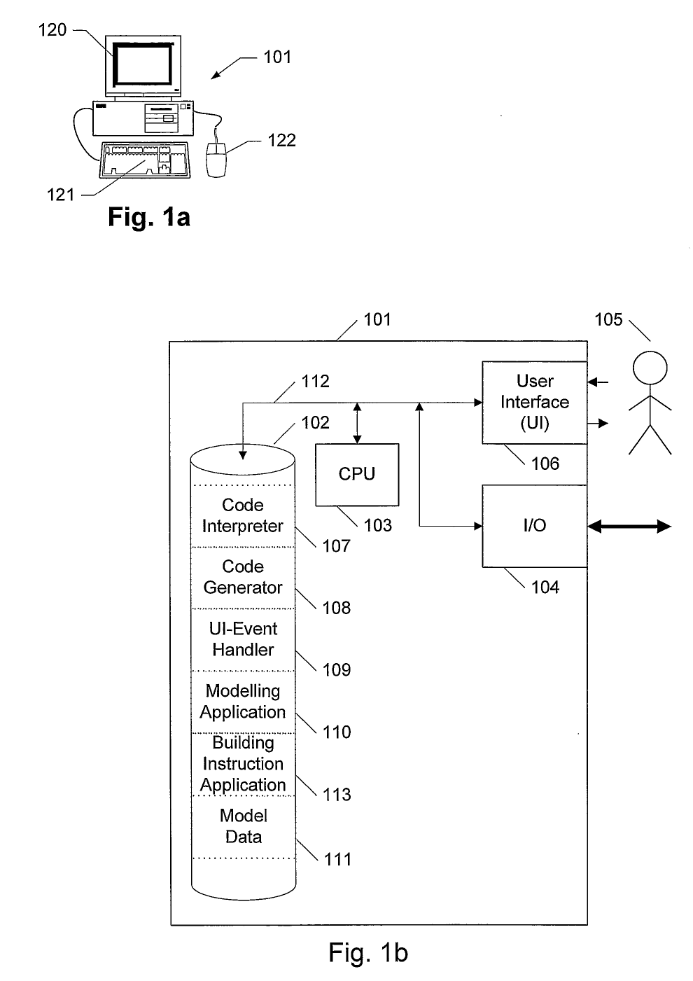

FIGS. 1a-b show a data processing system for generating building instructions of building block models;

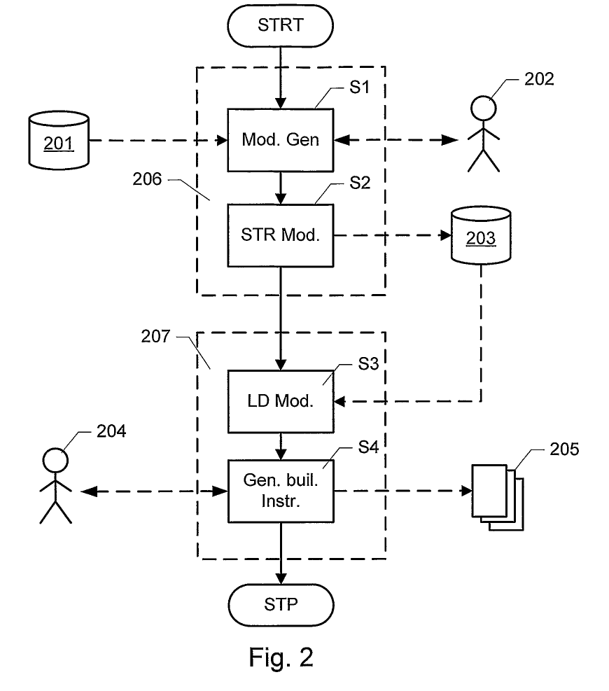

FIG. 2 shows a flow diagram of an embodiment of the building instruction generation;

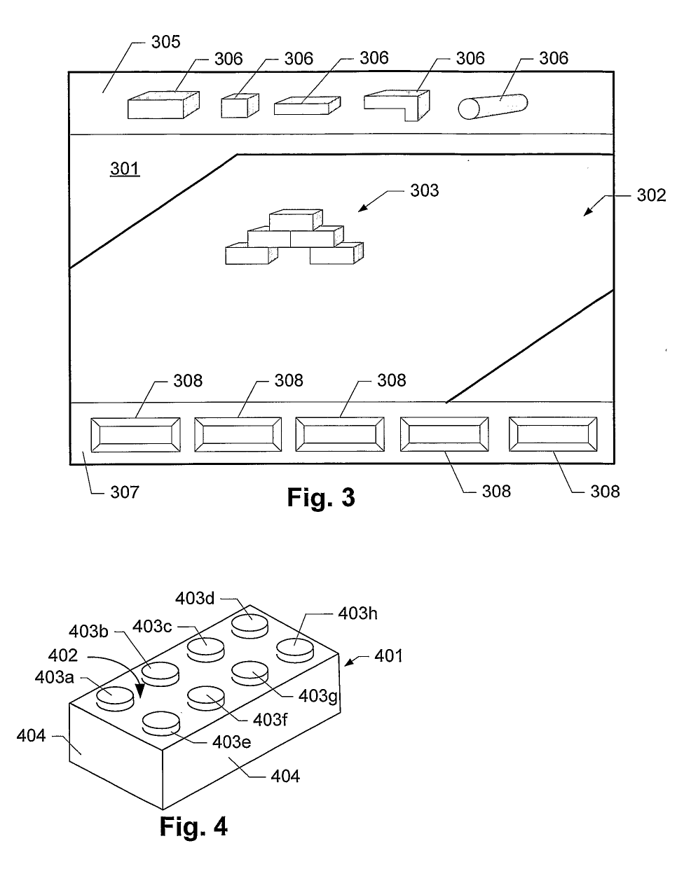

FIG. 3 shows a graphical user-interface of a virtual building block system;

FIG. 4 illustrates an example of a building block and its connection elements;

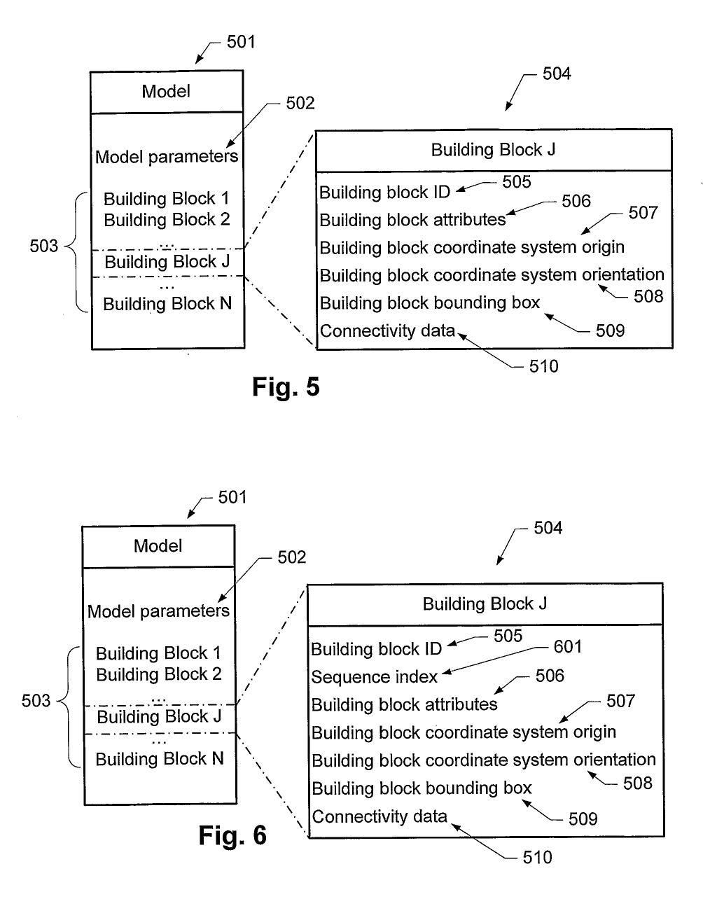

FIG. 5 illustrates an embodiment of a data structure for digitally representing a building block model;

FIG. 6 illustrates another embodiment of a data structure for digitally representing a building block model;

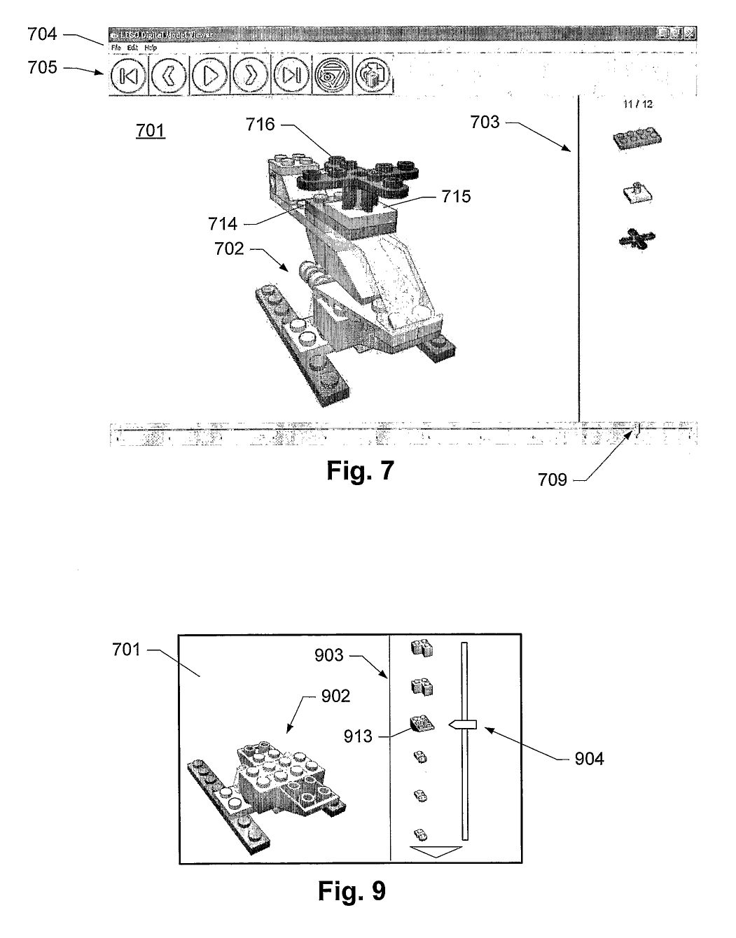

FIG. 7 illustrates an embodiment of a graphical user-interface of a building instruction application;

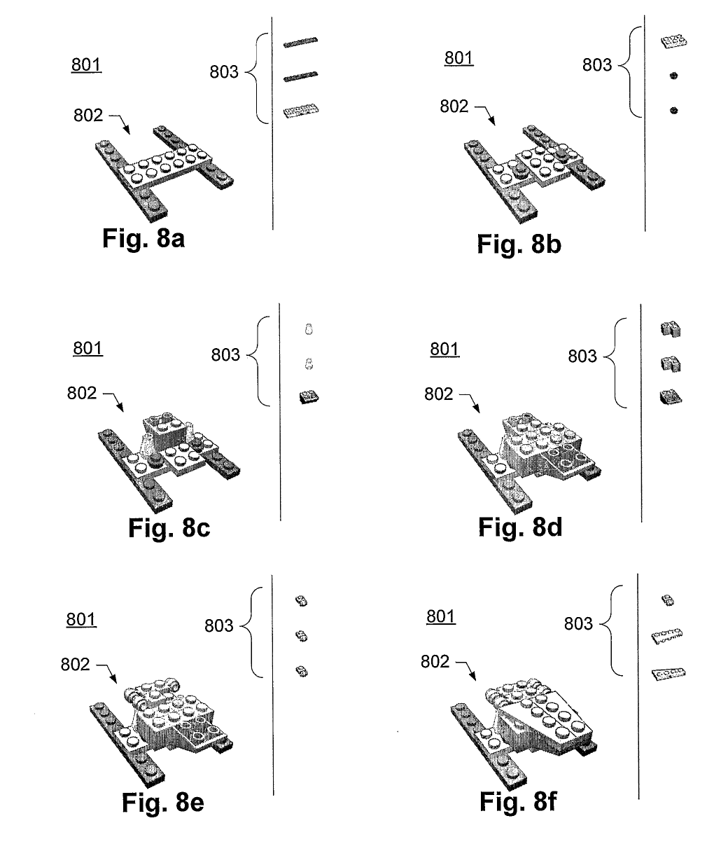

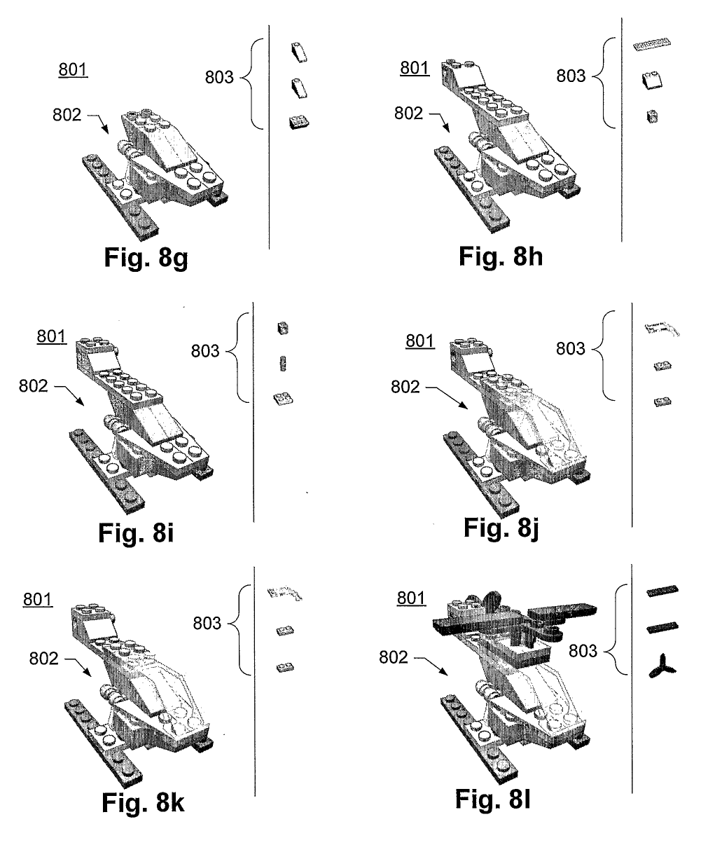

FIG. 8 illustrates an exemplary sequence of graphical representations of part-models forming step-by-step building instructions of a building block model;

FIG. 9 illustrates another embodiment of a viewing area of a graphical user-interface of a building instruction application;

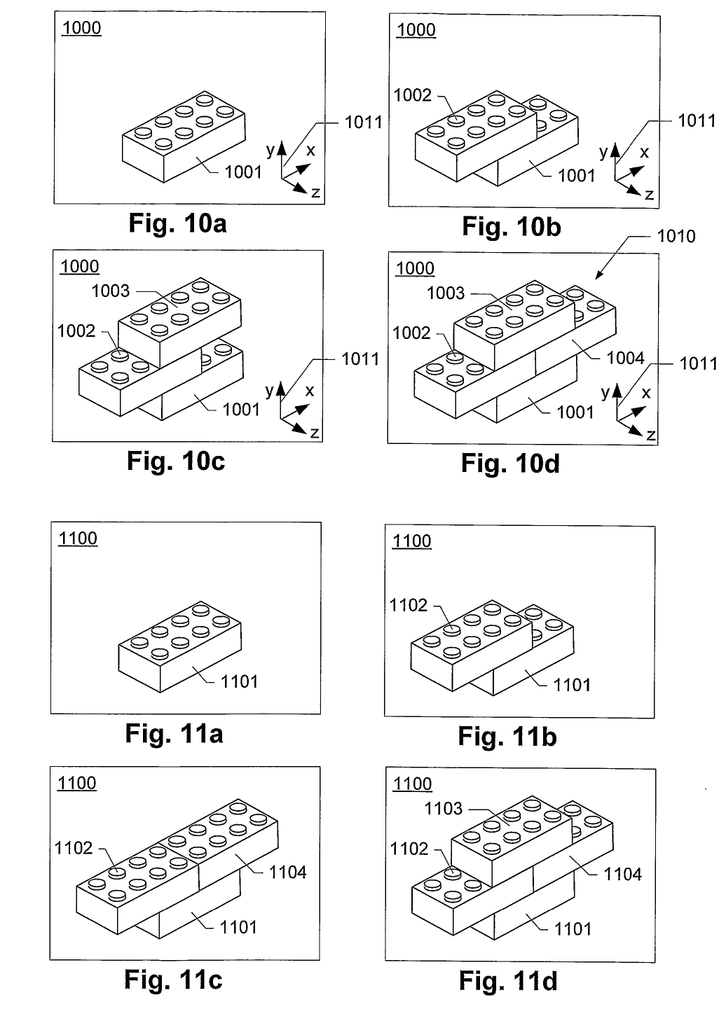

FIG. 10 illustrates an example of a sequence of construction steps of a virtual building block model; and

FIG. 11 illustrates an embodiment of building instructions for the virtual building block model created according to the sequence of FIG. 10.

FIGS. 1a-b show a data processing system for generating and manipulating computer-readable models of geometrical objects.

FIG. 1a shows a schematic view of an example of a computer system. The computer system comprises a suitably programmed computer 101, e.g. a personal computer, comprising a display 120, a keyboard 121 and a computer mouse 122 and/or another pointing device, such as a touch pad, a track ball, a light pen, a touch screen, or the like.

The computer system designated 101 is adapted to facilitate designing, storing, manipulating, and sharing virtual building block models as well as generating building instructions as described herein. The computer system 101 can be used as a stand-alone system or as a client in a client/server system. In some embodiments, the computer system further comprises one or more interfaces for connecting the computer with a computer network, e.g. the Internet.

FIG. 1b shows a block diagram of a data processing system for generating building instructions for building block models. The computer 101 comprises memory 102 which may partly be implemented as a volatile and partly as a non-volatile memory means, e.g. a random access memory (RAM) and a hard-disc. The memory has stored thereon model code interpreter 107, model code generator 108, UI-event handler 109, modelling application 110, and building instruction generator 113, each executable by the central processing unit 103. Further, the memory has stored therein model data 111, i.e. a set of data structures representing a digital representation of a virtual building block model.

The code interpreter 107 is adapted to read and interpret code defining a model, i.e. code representing the data structures of the building blocks of a model. In a preferred embodiment the code interpreter is adapted to read a model and to convert such a model into a known graphic format for presentation on a computer display, preferably a 3D rendering of the model.

The UI-event handler 109 is adapted to convert a user's interaction with a user interface into proper user commands recognizable by the code generator 108. A set of possible and recognisable commands can comprise: Getting a building block from a library of elements, placing a building block to be connected to another building block, disconnecting a building block, discarding a building block, manipulating a building block, a group of building blocks, etc., e.g. by initiating a rotation, etc. Along with each command, there may be associated a set of respective parameters, e.g. cursor coordinates with respect to the display coordinate system, types of building blocks, etc.

The code generator 108 is adapted to modify the data structures of a model in response to a user's commands. As a concurrent or subsequent task, the code interpreter can be executed for presenting the result of the code generator.

The modelling application 110 is adapted to control memory, files, the user interface, etc.

The building instruction application. 113 is adapted to read model data and to provide a user-interface for displaying part-models according to the stored sequence of building steps as described below. The building instruction application 113 uses functions provided by the code interpreter 107 and the UI-event handler 109 for the reading and graphical rendering of the models and for receiving user input, respectively. In alternative embodiments, the building instruction application is self-contained, i.e. not dependant on external software components.

A user 105 is capable of interacting with the computer system 101 by means of the user interface 106, preferably comprising a graphical user-interface displayed on a computer screen, and one or more input devices such as a keyboard and/or a pointing device.

In order to load, save, or communicate models, geometrical descriptions, or other data, the computer system comprises an input/output unit (I/O) 104. The input/output unit can be used as an interface to different types of storage media and different types of computer networks, e.g. the Internet. Further, the input/output unit (I/O) 104 can be used for exchanging models with other users e.g. interactively.

Data exchange between the memory 102, the central processing unit (CPU) 103, the user interface (UI) 106, and the input/output unit 104 is accomplished by means of the data bus 112.

It is noted that the data processing system of FIG. 1 is configured to execute both the modelling application and the building instructions application. However, in other embodiments the data processing system may be configured to only execute the building instruction application based on model data received from another computer on which a modelling application is executed. Likewise, on said other computer, the modelling application may be installed alone or in combination with the building instruction application.

FIG. 2 shows a flow diagram of an embodiment of the building instruction generation. The process is split up into a model generation stage 206 comprising steps S1 and S2, and a building instruction generation stage 207 comprising steps S3 and S4. The model generation stage 206 generates a digital representation of the building block model which is the input to the building instruction generation stage 207. It is an advantage of this modular process that both stages can be executed on the same or on different computers.

In initial step S1, a digital representation of a virtual building model is created by a model generation module, e.g. the modelling application 110 of FIG. 1b. The modelling is performed interactively allowing a user 202 to build a virtual building block model from a set of predefined virtual building blocks. The virtual building blocks are stored as respective data structures on a storage medium 201. For example, the data records may be stored locally on the computer on which the modelling application is executed. Alternatively or additionally, building block definitions may be retrieved from a storage device, e.g. a CD ROM, or via a computer network, e.g. by downloading building block definitions from a website on the Internet.

During model generation, the user typically creates a virtual building block model by selecting a number of building blocks one at a time and adding the selected building block to the model, i.e. positioning it with respect to the previously placed building blocks. Conveniently, such a positioning operation may be performed by a drag-and-drop operation or a similar interactive select-and-position operation.

An embodiment of a virtual reality modelling is described in U.S. Pat. No. 6,389,375. Furthermore, an embodiment of the process of interactively placing a new virtual building block into a scene including a 3D structure is described in co-pending International application PCT/DK2004/000341. Both documents are incorporated herein by reference in their entirety.

It is understood that the building process may further comprise the manipulation of building blocks already placed in the model, including deleting a building block, moving a building block to another position, re-orienting a building block, changing attributes/properties of a building block, and/or the like.

As the user typically positions one building block at a time, e.g. by adding a newly selected building block or by repositioning a previously placed building block, the building process imposes a sequential order of building steps. This sequential order is recorded by the modelling application. Nevertheless, in some embodiments several building blocks may be placed simultaneously. For example, in some embodiments the modelling application provides a copy-and-paste function where one or more interconnected building blocks may be selected in response to a user command, and a copy of the selected sub-structure may be positioned at a different position of the model. In this embodiment, each of the selected building blocks has a position in the sequential ordering. When generating a copy of the plurality of building blocks, they keep their relative sequential ordering with respect to the other selected and copied building blocks, thereby simply maintaining their relative sequential ordering with respect to another during the copy operation.

Once the creation of a model in step S1 is finished, a digital representation of the model is saved by the modelling application in step S2. Typically, the saving step is initiated by a corresponding user command.

In step S2, the digital representation is stored in a storage medium 203, e.g. on the local hard disk of the computer running the modelling application, on a CD ROM, on a diskette, or the like. Alternatively or additionally, the digital representation of the model may also be stored remotely, e.g. sent to another computer of a computer network where it is stored. For example, the digital representation may be uploaded to a web server, where it may be made available to other users.

Preferred data structures of the digital representation will be described below. In step S3, the digital representation including the stored information about the recorded sequential order of construction steps is loaded from the storage medium 203 by a building instruction application.

In step S4, the building instruction application generates a building instruction 205 from the loaded digital representation. In particular, the building instruction application generates a sequence of 3D views of part models, where each part-model is distinguished from the immediately preceding part-model in that a predetermined number of additional building blocks are added to the model according to the stored sequence of construction steps or according to a sequence derived therefrom. Preferred embodiments of the building instruction process are described below with reference to FIGS. 7 through 11. The building instructions 205 may be presented electronically, printed, or presented in another suitable way. In some embodiments, the generation of the building instructions may be controlled by a user 204. For example, the user may select the number of additional building blocks to be added in each step. Furthermore, the user may manipulate the generated 3D views, including changes of a camera position, etc., as will be described below. The user 204 may be the same or a different user as user 202.

FIG. 3 shows a graphical user-interface of a virtual building block system. The user-interface comprises a display area 301 showing a view of a 3D scene with a base plate 302 and a 3D structure 303 comprising a number of interconnected virtual building blocks 304. The scene is shown from a predetermined viewpoint. In the following, this viewpoint will also be referred to as the (virtual) camera position, as it correspond to a position from which a camera would record a picture of a real structure corresponding to the graphical picture shown in the display area.

Each of the building blocks 304 corresponds to an active element of the graphical user-interface that may be activated, e.g. by clicking on it with a computer mouse, to select that building block. In one embodiment, a selected virtual building block changes appearance. For example, the selected building block may change colour, texture, etc.; it may be highlighted by showing a bounding box around the selected building block, or the like. A user may manipulate a selected building block, e.g. changing its properties, e.g. its colour, deleting it, performing a copy and paste operation, dragging it to a different position, rotating it, or the like.

The user-interface further comprises a palette panel 305 comprising a number of different building blocks 306 that may be selected by the user. For example, a user may click on one of the building blocks 306 with the mouse, thereby selecting that building block, and drag the selected building block into the display area 301 to connect it to the structure 303 or to the base plate 302.

The user-interface further comprises a menu bar 307 comprising a number of menu buttons 308 for activating various functions or tools. For example, the tool bar may comprise a rotation tool for changing the virtual camera position, thereby allowing the user to view the building area from different directions. The menu bar may further comprise a zoom tool for zooming in and out to/from the 3D scene. Other examples of tools include a palette tool for selecting different palettes 305 each comprising a different set of building blocks, a colouring tool for colouring parts of the structure, an eraser tool for erasing building blocks, etc.

The menu bar 307 may further provide standard functions, such as functions for saving a model, opening a previously saved model, printing an image of a model, a help function, etc.

FIG. 4 illustrates an example of a building block and its connection elements. In particular, FIG. 4 shows a perspective view of a building block 401. The building block 401 has a top surface 402 with eight knobs 403a-h that can engage with corresponding holes of another building block, e.g. holes on the bottom surface of another building block. Correspondingly, building block 401 comprises a bottom surface (not shown) with corresponding holes. The building block 401 further comprises side faces 404 that do not comprise any connection elements.

Generally, the connection elements may be grouped into different classes of connection elements, e.g. connectors, receptors, and mixed elements. Connectors are connection elements which may be received by a receptor of another building block, thereby providing a connection between the building blocks. For example, a connector may fit between parts of another element, into a hole, or the like. Receptors are connection elements which can receive a connector of another building block. Mixed elements are parts that can function both as a receptor and a connector, typically depending on the type of the cooperating connection element of the other building block.

Building blocks of the type illustrated in FIG. 4 are available under the name LEGO in a large variety of shapes, sizes, and colors. Furthermore, such building blocks are available with a variety of different connection elements. It is understood that the above building block merely serves as examples of possible building blocks.

FIG. 5 illustrates an embodiment of data structure for digitally representing a building block model. During the creation of a virtual building block model, the modelling application maintains a data structure representing the model as created so far. When saving the model, a corresponding data structure is saved. In one embodiment, the saved data structure 501 comprises one or more data records 502 including global model parameters relating to the entire model. Examples of such model parameters include a model name, a name of a model creator, a program version number of the modelling application, a creation date, etc. The model data structure 501 further comprises a list 503 of building block data structures. In the example of FIG. 5, the list comprises N data structures “Building Block 1”, “Building Block 2”, . . . , “Building Block J”, . . . , “Building Block N”.

Each building block data record of the list 503 has the structure illustrated by the data structure 504 for “Building block J”.

In particular, each building block data record comprises a building block ID 505, indicating an identifier corresponding to the type of building block. Preferably, the building block ID uniquely identifies the properties of the building block or type of building block.

The building block data record further comprises a number of building block attributes 506 indicating one or more attributes of the building block, such as color, texture, decorations, etc.

Furthermore, the building block data record 504 comprises data items 507 and 508 representing the position and orientation of an internal coordinate system of the building block, respectively. The position and orientation of the building block are defined by the coordinates of an origin of the internal coordinate system of the building block with respect to a global “world” coordinate system, and by the orientation of the internal coordinate system with respect to the global coordinate system.

An example of a data format for storing virtual building models that includes a hierarchy of coordinate systems is disclosed in U.S. Pat. No. 6,389,375.

Furthermore, the building block data record 504 comprises data items 509 and 510 representing one or more bounding boxes and connectivity data of the building block, respectively, used in the detection of connectivity properties of the building block with other building blocks. An embodiment of a representation of the connectivity data of the type of building blocks shown in FIG. 4 includes data structures representing the planes defined by the surface of a bounding box of the building block. The connection elements of the building block are located in these planes, such that each connection element has an axis associated with it. The axes of all connection elements in the same plane correspond to respective grid points of a regular grid, e.g. an orthogonal grid, with fixed distances between neighbouring grid points. The planes associated to the building block 401 of FIG. 4 are pairwise parallel to each other, and they include a set of horizontal planes corresponding to the top and bottom faces of the building block and a number of vertical planes corresponding to the side faces of the building block. Preferably, the distances between neighbouring grid points are the same in all horizontal planes. In one embodiment, the distances between neighbouring grid points in vertical planes are different from the distances between neighbouring grid points in horizontal planes. A digital representation of the connectivity properties of the building blocks of the type shown in FIG. 4 and the enforcement of corresponding connectivity rules during the virtual model generation are disclosed in WO 04/034333 which is incorporated in its entirety herein by reference.

It is understood that the digital representation may be encoded in any suitable data or file format, e.g. as a binary file, as a text file according to predetermined modelling description language, or the like.

In the above example of a model data structure, the building blocks are ordered in sequential order of their respective placement. Hence Building Block 1 was the first building block placed in the model and Building Block N was the most recently placed or re-positioned building block. Each time, the model is manipulated the above data structure is updated.

Examples of such manipulations include
The change of attributes of a building block, e.g. its colour or appearance. This change does not involve a change in the sequential order of building blocks.
The addition of a new building block: This change includes appending a new building block data structure to the list, resulting in a list of N+1 building blocks, with Building Block N+1 being the newly added building block.
The deletion of a building block: This change includes the removal of a building block data record from the list.
The repositioning of a building block, e.g. the moving of a building block to a new position, a change in the orientation of the building block, or a combination the above: This change involves the removal of the corresponding building block data structure from its current position in the list and appending the data record at the end of the list with the corresponding new position and orientation coordinates as well as any changes in the connectivity data.

FIG. 6 illustrates another embodiment of a data structure for digitally representing a building block model. This embodiment is similar to the data structure of FIG. 5. However, in this embodiment, each building block data record of the list 503 comprises a sequence index 601 indicating the position of the building block in the sequential order in which the building blocks have been added to the model or have been repositioned within the model.

FIG. 7 illustrates an embodiment of a graphical user-interface of a building instruction application program. The user-interface comprises a viewing area 701 illustrating a graphical representation of a step of a set of step-by-step building instructions. The graphical representation shows a 3D view of a part-model 702 shown from a predetermined camera position. The part model 702 consists of a subset of all the building blocks of the complete model, where the subset includes the initially positioned building blocks. The viewing area 701 further comprises a graphical representation 703 of the most recently placed building blocks, i.e. the building blocks that distinguish the present part-model 702 from the part-model of the previous step. In this example, these are the building blocks 714, 715, and 716 of the part-model 702.

The user-interface further comprises a slider control element 709 which may be moved in discrete intervals by a corresponding drag operation with the mouse, allowing a user to select any of the steps of the step-by-step instructions. In the example of FIG. 7, three new building blocks are added in each step of the instructions.

The user-interface further comprises button control elements 705 that allow a user to invoke a number of frequently used functions such as sequentially flipping through the graphical representations in a forward and backward direction, respectively, jumping to the first and last step of the instructions, changing the camera position, printing the generated building instructions, and initiating an “auto-play” function. The auto-play function displays the sequence of part models one by one such that each part model is shown for a predetermined period of time. Preferably, the user may configure the viewing time for each part-model in the auto-play function.

Preferably, the number of building blocks added in each step is configurable. In the example of FIG. 7, it is assumed that this number is set to 3, i.e. three building blocks are added to the model in each step of the building instructions. Hence, the first part-model comprises the first, second, and third building blocks of the sequential order of the recorded construction steps, while the second part model includes the first, second, third, fourth, fifths and sixth building blocks, and so forth.

Finally, the user interface comprises a number of pull-down menus 704, allowing a user to initiate functionality such as a help function, functions for changing the camera position, zoom functions, etc. Further functionality provided by the building instruction application includes the loading of digital representations, a print function for printing the graphical representations of the part-models, and export functions for exporting the sequence of graphical representations of the part models, e.g. in a HTML format, or any other suitable graphical file format, such as TIF, JPG, BMP, etc.

Further examples of functions provided by the building instruction application include a bill of material function, allowing a user to view or print a list of all building blocks in the model.

FIGS. 8a-l illustrate an exemplary sequence of graphical representations of part-models forming step-by-step building instructions of a building block model. Each graphical representation is shown in a display area 801 and comprises a view of a part model 802 and a view of the building blocks 803 that are added in the current step. Again, in this example, three building blocks are added in each step. Hence, FIG. 8a shows an initial part model of the first three building blocks 803 of the sequential order, i.e. the first three building blocks that were added to the model during model creation. FIG. 8b illustrates the next part model including 6 building blocks, i.e. the three building blocks of FIG. 8a and three additional building blocks. FIGS. 8c through 8k illustrate the subsequent incremental part models in the sequential order of the step-by-step instructions. Finally, FIG. 81 shows the complete model after the final three building blocks are added. It is understood that in cases where the total number of building blocks in the model is not a multiple of the number of building blocks that are added in each step, a different number of blocks are added in one of the steps, e.g. in the last step.

It is understood that, in some embodiments, more than one part models may be displayed simultaneously in the viewing area of the user-interface.

FIG. 9 illustrates another embodiment of a viewing area of a graphical user-interface of a building instruction application. In this embodiment, the viewing area 701 shows the current part model 702 and the sequence of building blocks 903 in the sequential order in which they were added to the model. A slider control element 904 next to the sequence of building blocks 903 indicates the current position in the sequence: The part model 902 currently displayed in the viewing area 901 includes all building blocks up to the building block 913 indicated by the current slider position.

By moving the slider control element 904 up and down, a user can select which part-model to view in the viewing area. Hence, in this embodiment, each incremental part model only differs by a single brick from the preceding part model.

FIG. 10 illustrates an example of a sequence of building steps of a virtual building block model. FIGS. 10a-d show the display area 1000 of a modelling application, e.g. the modelling application described in connection with FIG. 3, at different steps of a sequence of building steps resulting in a virtual building block model 1010. For simplicity, it is assumed in this example that the building block model is created from one type of building blocks only, namely the type described in connection with FIG. 4. FIG. 10a shows the display area after placement of the first building block 1001. FIG. 10b shows the display area after placement of the second building block 1002 partially on top of the second building block, such that some of the knobs on the top surface of the first building block 1001 engage with corresponding cavities in the bottom surface of the second building block 1002. FIG. 10c shows the display area after placement of a third building block 1003, and FIG. 10d shows the display area after placement of a fourth building block 1004.

It should be noted that the placement of the fourth building block 1004 in this position would not be possible for the physical building blocks of the type described in connection with FIG. 4 without first removing either block 1001 or 1003, since the knobs on the respective top surfaces of building blocks 1001 and 1004 prevent the insertion of building block 1004 in the gap between building blocks 1001 and 1003. In some embodiments of a virtual modelling application, the positioning of building block 1004 may nevertheless be allowed, since the resulting position is valid. Once positioned inside the gap, the knobs of building blocks 1001 and 1004 correctly engage with the corresponding cavities of building blocks 1004 and 1003, respectively. Allowing such a positioning in the virtual modelling application provides a more efficient manipulation of building blocks, such as a replacement of a building block in the centre of a model without the need of undoing a large number of other building steps.

Nevertheless, when generating building instructions for the construction of physical models it may be desirable to ensure that the sequence of building steps is possible to perform in the order shown.

This problem is solved by modifying the sequence of recorded building steps according to a secondary ordering condition resulting in a derived sequence. An example of such a secondary condition in the example of FIG. 10 is the position of the building blocks. For example, the coordinates of the building blocks in the y-direction of the global coordinate system 1011 may be used as a secondary sorting criterion. The y-direction in the global coordinate system of FIG. 10 corresponds to the vertical direction from a base plate, i.e. the natural direction of stacking building blocks on top of each other.

The list of building block data records generated by the modelling application for the example of FIG. 10 has the following sequential order:

| Building block | y-coordinate |
|---|---|
| Building block 1001 | y1 |
| Building block 1002 | y2 |
| Building block 1003 | y3 |
| Building block 1004 | y2 |

Here, the y-coordinates of the building blocks are denoted y1, y2, and y3, where y1<y2<y3.

In one embodiment, the above recorded sequential order is modified by sorting the building blocks according to their y coordinates. Building blocks with equal y-coordinates maintain their relative sequential order as recorded.

This modification results in the following modified sequence:

| Building block | y-coordinate |
|---|---|
| Building block 1001 | y1 |
| Building block 1002 | y2 |
| Building block 1004 | y2 |
| Building block 1003 | y3 |

Hence, building blocks 1003 and 1004 are interchanged. The corresponding steps of the building instruction are shown in FIGS. 11a-d where additional building block is added in each step.

FIG. 11 illustrates an embodiment of building instructions for the virtual building block model created according to the sequence of FIG. 10. In particular, FIGS. 11a-d show a display area 1100 of a user-interface of a building instruction application showing part-models of respective steps of the generated step-by-step building instructions. In the example of FIG. 11, the sequence of steps in the building instructions is generated from the modified sequence of steps described in connection with FIG. 10. Accordingly, FIG. 11a shows the initial part-model with the first building block 1101 of the instruction sequence. FIG. 11b shows the part model after addition of the second building block 1102 of the instruction sequence. FIG. 11c shows the part model after addition of the third building block 1104 of the instruction sequence. Finally, FIG. 11d shows the complete model after addition of the fourth building block 1103 of the instruction sequence.

1. A computer-implemented method of generating building instructions for a building block model, the model including a plurality of building blocks; the method comprising
a) retrieving a digital representation of the building block model; wherein said digital representation is indicative of a sequential construction order in which a plurality of virtual building blocks have been positioned in response to user commands during a computer-implemented virtual construction process, said virtual construction process resulting in a virtual building block model; and
b) generating graphical representations of at least a first and a second part model of respective first and second subsets of said plurality of virtual building blocks; wherein the second subset includes the first subset and a predetermined number of additional virtual building blocks of said plurality of virtual building blocks; and wherein the additional virtual building blocks are subsequent to all virtual building blocks in the first subset with respect to a sequential instruction order derived from the sequential construction order.

2. A method according to claim 1, wherein the digital representation comprises a sequence of data records, each representing one of the plurality of building blocks; and wherein said sequence represents the sequential construction order in which the virtual building blocks where positioned during the model generation.

3. A method according to claim 1, wherein the digital representation comprises a plurality of data records, each representing one of the plurality of building blocks; and wherein each data record includes a data item indicative of a position of the corresponding virtual building block in said sequential construction order in which the virtual building blocks where positioned during the model generation.

4. A method according to claim 1, wherein the sequential instruction order is identical to the sequential construction order.

5. A method according to claim 1, further comprising modifying the sequential construction order according to a predetermined sorting criterion to obtain the sequential instruction order.

6. A method according to claim 5, wherein the digital representation includes respective position coordinates of each of the virtual building blocks with respect to a predetermined coordinate system; and wherein said sorting criterion includes said position coordinates along at least one predetermined direction.

7. A method according to claim 1, further comprising generating the digital representation of the building block model by means of a computer-implemented construction environment for interactively constructing a virtual building block model, wherein the generating includes:
positioning a plurality of virtual building blocks in respective positions relative to another, resulting in a virtual building block model, wherein the virtual building blocks are positioned in a sequential construction order in response to user commands;
storing the digital representation of said virtual building block model including information about said sequential construction order.

8. A method according to claim 7, wherein the computer-implemented construction environment is configured to enforce a predetermined set of restrictions imposed on the placement of building blocks with respect to each other.

9. A method according to claim 8, wherein the computer-implemented construction environment is configured to retrieve connectivity information of the corresponding connection elements of the virtual building blocks indicative of whether the connection elements of two building blocks positioned in a predetermined proximity from each other provide a connection between the two building blocks.

10. A method according to claim 1, wherein each of the first and second subsets constitutes an uninterrupted part-sequence of virtual building blocks from the stored sequential instruction order.

11. A method according to claim 1, wherein generating graphical representations comprises generating a sequence of graphical representations of a corresponding sequence of part-models including an initial part-model, a sequence of incremental part-models, and a complete model; wherein each of the incremental part-models includes all virtual building blocks of the immediately preceding incremental part-model of the sequence and a predetermined number of additional virtual building blocks from the plurality of building blocks; and wherein the complete model comprises all of the plurality of virtual building blocks.

12. A method according to claim 1, further comprising providing a user interface facilitating a user-controlled manipulation of the generated graphical representations.

13. A method according claim 12, wherein the user-interface provides at least one of the operations zoom and rotate.

14. A method according to claim 12, wherein the user interface provides functionality for viewing selected ones of the generated graphical representations.

15. A method according to claim 14, wherein the user interface provides functionality for viewing a sequence of graphical representations of part-models where each graphical representation is displayed for a predetermined period of time before the next graphical representation is automatically displayed.

16. A method according to claim 12, wherein the user interface further provides functionality for least one of printing at least one of the graphical representations and storing at least one of the graphical representations in a predetermined file format.

17. A method according to claim 1, wherein the predetermined number is user-selectable.

18. A method according to claim 1, wherein the predetermined number is between 1 and 6, preferably between 2 and 4.

19. A method according to claim 1, further comprising presenting the second graphical representation of the model together with a graphical representation of the additional building blocks which distinguish the second part model from the first part model.

20. A method according to claim 1, wherein the sequential construction order is indicative of a sequential order of construction operations in response to user commands, wherein the construction operations include one or more repositioning operations in which one or more previously added building blocks are repositioned within the virtual building block model.

21. (canceled)

22. (canceled)

23. (canceled)

24. (canceled)

25. (canceled)

26. A computer readable medium comprising program code means adapted to cause a data processing system to
a) retrieve a digital representation of a building block model; wherein said digital representation is indicative of a sequential construction order in which a plurality of virtual building blocks have been positioned in response to user commands during a computer-implemented virtual construction process, said virtual construction process resulting in a virtual building block model; and
b) generate graphical representations of at least a first and a second part model of respective first and second subsets of said plurality of virtual building blocks; wherein the second subset includes the first subset and a predetermined number of additional virtual building blocks of said plurality of virtual building blocks; and wherein the additional virtual building blocks are subsequent to all virtual building blocks in the first subset with respect to a sequential instruction order derived from the sequential construction order.

27. A computer readable medium according to claim 26 further comprising a component for performing the step of generating a digital representation of the building block model by means of a computer-implemented construction environment for interactively constructing a virtual building block model.
